(19) United States
(12) Patent Application Publication
(10) Pub. No.: US 2012/0153006 A1
(43) Pub. Date: Jun. 21, 2012

(54) ULTRASONIC WELDING SYSTEM AND METHOD FOR FORMING A WELD JOINT

(75) Inventors: William Koetting, Davisburg, MI (US); Alexander Khakhalev, Troy, MI (US); Michael Nielson, Royal Oak, MI (US)

(73) Assignee: LG CHEM, LTD., Seoul (KR)

(21) Appl. No.: 12/970,031

(22) Filed: Dec. 16, 2010

(51) Int. Cl. B23K 20/10; B23K 1/06

(52) U.S. Cl. 228/102; 228/1.1

(57) ABSTRACT

An ultrasonic welding system and a method are provided. The system includes an ultrasonic welding device and a controller that generates control signals for inducing the device to form a first weld joint. The system further includes a power adjusting unit having a desired output power level curve indicating desired power levels over time for obtaining a desired weld joint. The unit receives data from the controller indicating power levels when forming the first weld joint. The unit compares a power level output by the controller at a first time with an associated power level of the curve at the first time, and induces the controller to increase the power level at a second time if the power level output by the controller at the first time is less than the associated power level of the curve at the first time.

### BACKGROUND

Ultrasonic welding systems have been utilized to form weld joints. The ultrasonic welding system may undesirably have variability in an amount of energy utilized to form weld joints such that the weld joints may not have desired structural and electrical characteristics.

Accordingly, the inventors herein have recognized a need for an improved ultrasonic welding system and a method for forming a weld joint that reduces and/or minimizes the above-mentioned deficiency.

### SUMMARY

An ultrasonic welding system in accordance with an exemplary embodiment is provided. The ultrasonic welding system includes an ultrasonic welding device and an ultrasonic welding controller configured to generate control signals for inducing the ultrasonic welding device to commence forming a first weld joint. The ultrasonic welding system further includes a power adjusting unit operably communicating with the ultrasonic welding controller. The power adjusting unit has a desired output power level curve stored therein. The desired output power level curve indicates desired power levels over time for obtaining a desired weld joint. The power adjusting unit is configured to receive data from the ultrasonic welding controller indicating power levels output by the ultrasonic welding controller to the ultrasonic welding device when forming the first weld joint. The power adjusting unit is further configured to compare a power level output by the ultrasonic welding controller at a first time with an associated power level of the desired output power level curve at the first time. The power adjusting unit is further configured to induce the ultrasonic welding controller to increase the power level output by the ultrasonic welding controller to the ultrasonic welding device at a second time after the first time if the power level output by the ultrasonic welding controller at the first time is less than the associated power level of the desired output power level curve at the first time, such that a total amount of energy output by the ultrasonic welding controller over welding time interval to obtain the first weld joint corresponds to an amount of energy defined by the desired output power level curve.

A method for forming a weld joint utilizing an ultrasonic welding system in accordance with another exemplary embodiment is provided. The ultrasonic welding system has an ultrasonic welding device, an ultrasonic welding controller, and a power adjusting unit. The method includes generating control signals for inducing the ultrasonic welding device to commence forming a first weld joint, utilizing the ultrasonic welding controller. The method further includes accessing a desired output power level curve utilizing the power adjusting unit, the desired output power level curve indicating desired power levels over time for obtaining a desired weld joint. The method further includes receiving data from the ultrasonic welding controller at the power adjusting unit. The data indicates power levels output by the ultrasonic welding controller to the ultrasonic welding device when forming the first weld joint. The method further includes comparing a power level output by the ultrasonic welding controller at a first time with an associated power level of the desired output power level curve at the first time utilizing the power adjusting unit. The method further includes generating commands to induce the ultrasonic welding controller to increase the power level output by the ultrasonic welding controller to the ultrasonic welding device at a second time after the first time utilizing the power adjusting unit if the power level output by the ultrasonic welding controller at the first time is less than the associated power level of the desired output power level curve at the first time, such that the total amount of energy output by the ultrasonic welding controller over a welding time interval to obtain the first weld joint corresponds to the amount of energy defined by the desired output power level curve.

### BRIEF DESCRIPTION OF THE DRAWINGS

FIG. 1 is a schematic of an ultrasonic welding system having an ultrasonic welding device, an ultrasonic welding controller, and a power adjusting unit, in accordance with an exemplary embodiment;

FIG. 2 is a schematic of battery cells having electrical terminals that are coupled together with weld joints;

FIG. 3 is a cross-sectional schematic of the battery cells of FIG. 2;

FIG. 4 is a graph of a desired output power level curve utilized by the power adjusting unit of FIG. 1;

FIG. 5 is a graph of the desired output power level curve of FIG. 4 and an exemplary power level curve;

FIG. 6 is a graph of the desired output power level curve of FIG. 4 and another exemplary power level curve; and

FIG. 7 is a flowchart of a method for forming a weld joint in accordance with another exemplary embodiment.

### DETAILED DESCRIPTION

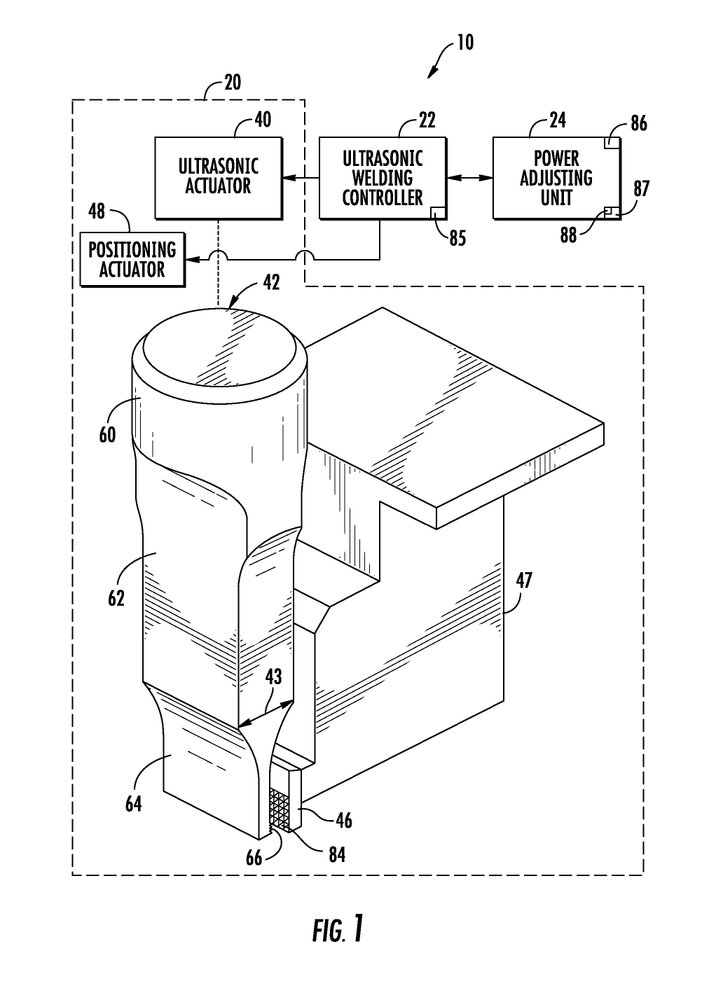

Referring to FIG. 1, an ultrasonic welding system 10 for forming weld joints in components in accordance with an exemplary embodiment is illustrated. The ultrasonic welding system 10 includes an ultrasonic welding device 20, an ultrasonic welding controller 22, and a power adjusting unit 24. An advantage of the system 10 is that the system utilizes a power adjusting unit 24 that compares actual output power levels to a desired output power level curve to adjust the power level of the controller 22 during formation of a weld joint to obtain a desired weld joint.

For purposes of understanding, a desired weld joint is a weld joint that has desired structural characteristics and electrical characteristics including a desired resistivity and a desired tensile strength for example. In one exemplary embodiment, the system 10 can advantageously produce weld joints having a tensile strength of 400-2000 Newtons with a resistivity in a range of 25-100 micro-ohms with a weld joint surface area range of 50 millimeters²-200 millimeters². Thus, a weld joint can be formed that has a tensile strength substantially equal to a tensile strength of foil cell terminals which is desirable for cell terminal and weld joint durability. Further, the formed weld joints can withstand vibrational testing of three anticipated life-cycles of the weld joints. Still further, the relatively low resistivity of the weld joint allows battery cells connected in parallel to output a current at least seven-times a normal current capacity while only raising a temperature of the battery cells 20° C. above an ambient temperature.

The ultrasonic welding device 20 is configured to form weld joints in components such as electrical terminals of battery cells. The ultrasonic welding device 20 includes an ultrasonic actuator 40, and ultrasonic horn 42, an anvil 46, a bracket 47, and a positioning actuator 48.

The ultrasonic actuator 40 is configured to vibrate the ultrasonic horn 42 in response to receiving control signals from the ultrasonic welding controller 22. The ultrasonic actuator 40 is operably coupled to the ultrasonic horn 42.

The ultrasonic horn 42 is configured to vibrate and to contact an electrical terminal disposed between the horn 42 and the anvil 46 to form one or more weld joints on the electrical terminal. The ultrasonic horn 42 includes a head portion 60, a central portion 62, and a tip portion 64. The head portion 60 is operably coupled to the ultrasonic actuator 40. The central portion 62 is coupled between the head portion 60 and the tip portion 64. The tip portion 64 includes a knurled region 66 that faces the anvil 46. In one exemplary embodiment, the ultrasonic horn 42 is constructed of tool steel such as M2 steel for example.

The anvil 46 is configured to contact one or more cell terminals of battery cells disposed between the anvil 46 and the ultrasonic horn 42. The anvil 46 includes a knurled region 84 disposed proximate to the ultrasonic horn 42. In one exemplary embodiment, the anvil 46 is constructed of M2 steel. Of course, in alternative embodiments, the anvil 46 could be constructed of other materials known to those skilled in the art. The anvil 46 is operably coupled to the bracket 47 that holds the anvil 46 thereon. In one exemplary embodiment, the bracket 47 can also be constructed of M2 steel. Of course, in alternative embodiments, the bracket 47 could be constructed of other materials known to those skilled in the art.

The positioning actuator 48 is configured to move the ultrasonic horn 42 axially toward the anvil 46 and away from the anvil 46 along an axis 43 in response to respective control signals from the ultrasonic welding controller 22. The positioning actuator 48 is operably coupled to the ultrasonic horn 42.

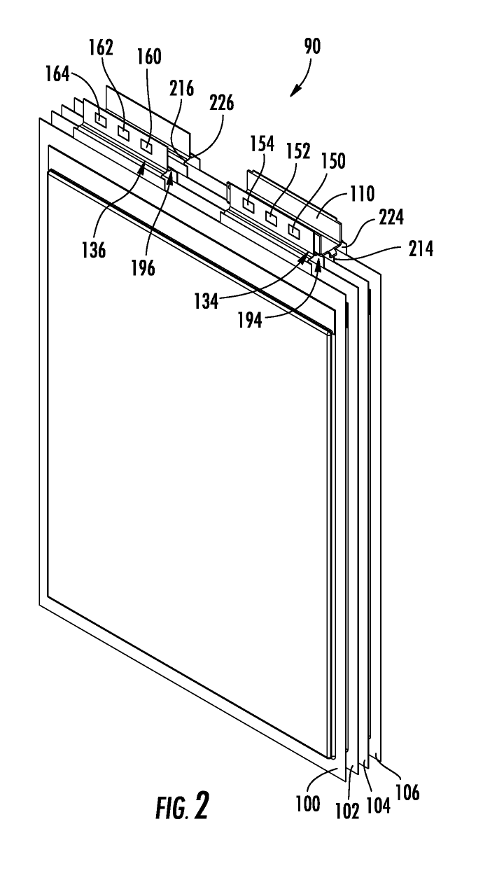

Referring to FIGS. 1 and 2, during operation of the ultrasonic welding system 10, cell terminals of battery cells and portions of an interconnect member 110 of a battery module 90 are disposed between the knurled region 66 of the ultrasonic horn 42 and the knurled region 84 of the anvil 46. The ultrasonic horn 42 is vibrated and contacts or impacts an adjacent cell terminal to form weld joints in the cell terminals and the interconnect member 110.

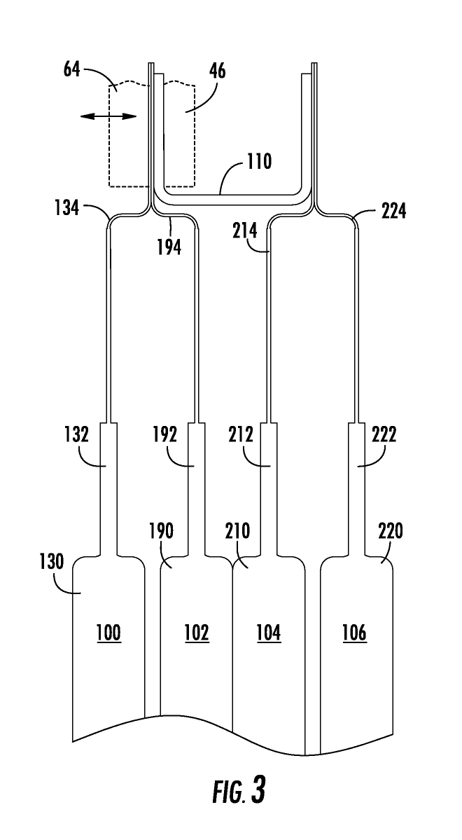

Referring to FIGS. 1-3, in one exemplary embodiment, the battery module 90 includes battery cells 100, 102, 104, 106 that are lithium-ion battery cells. The structure of the battery cells 100-106 are substantially similar to one another. Of course, in alternative embodiments, the battery cells could be other types of battery cells known to those skilled in the art.

The battery cell 100 includes a body portion 130, an extension portion 132 extending around a periphery of the body portion 130, and cell terminals 134, 136 extending outwardly from the extension portion 132. In one exemplary embodiment, the cell terminal 134 is a nickel-plated copper cell terminal and the cell terminal 136 is an aluminum cell terminal.

The battery cell 102 includes a body portion 190, an extension portion 192 extending around a periphery of the body portion 190, and cell terminals 194, 196 extending outwardly from the extension portion 192. In one exemplary embodiment, the cell terminal 194 is a nickel-plated copper cell terminal and the cell terminal 196 is an aluminum cell terminal.

Weld joints 150, 152, 154 formed by the system 10 couple the electrical terminals 134, 194 to the interconnect member 110. Also, weld joints 160, 162, 164 formed by the system 10 couple the electrical terminals 136, 196 to the interconnect member 110.

The battery cell 104 includes a body portion 210, an extension portion 212 extending around a periphery of the body portion 210, and cell terminals 214, 216 extending outwardly from the extension portion 212. In one exemplary embodiment, the cell terminal 214 is a nickel-plated copper cell terminal and the cell terminal 216 is an aluminum cell terminal.

The battery cell 106 includes a body portion 220, an extension portion 222 extending around a periphery of the body portion 220, and cell terminals 224, 226 extending outwardly from the extension portion 222. In one exemplary embodiment, the cell terminal 224 is a nickel-plated copper cell terminal and the cell terminal 226 is an aluminum cell terminal.

Weld joints (not shown) formed by the system 10 couple the electrical terminals 214, 224 to the interconnect member 110. Also, weld joints (not shown) formed by the system 10 couple the electrical terminals 216, 226 together.

Referring again to FIG. 1, the ultrasonic welding controller 22 includes an internal microprocessor 85 configured to generate control signals to induce the ultrasonic welding device 20 to form weld joints. The microprocessor 85 is further configured to generate control signals to induce the positioning actuator 48 to move the ultrasonic horn 42 axially toward the anvil 46 and away from the anvil 46. The microprocessor 85 is further configured to receive control signals from the power adjusting unit 24 to adjust power levels output by the controller 22 to the ultrasonic welding device 20 and in particular to the ultrasonic actuator 40.

Referring to FIGS. 1 and 4-6, the power adjusting unit 24 has a microprocessor 86 operably coupled to a memory device 87. The microprocessor 86 is configured to access a desired output power level curve 300 stored in the memory device 87. The desired output power level curve 300 may be stored in the form of a table of values or as an equation in the memory device 87. The desired output power level curve 300 indicates desired power levels over time for obtaining a desired weld joint. An area under the curve 300 corresponds to the total amount of energy defined by the curve 300 for forming a desired weld joint. The desired output power level curve 300 can be generated by a neural network algorithm executing on the microprocessor 86 that generates the curve 300 based on learned power level data obtained from the ultrasonic welding controller 22 during formation of several desired weld joints during a training operational mode. The desired weld joints are weld joints that have desired electrical and structural characteristics including a desired resistivity and a desired tensile strength for example. After the training operational mode, during normal operation, the microprocessor 86 of the power adjusting unit 87 is configured to receive data from the microprocessor 85 of the ultrasonic welding controller 22 indicating power levels output by the controller 22 to the ultrasonic welding device 20 when forming the first weld joint.

The microprocessor 86 is further configured to compare a power level output by the controller 22 at a first time (T₁) with an associated power level of the desired output power level curve 300 at the first time (T₁).

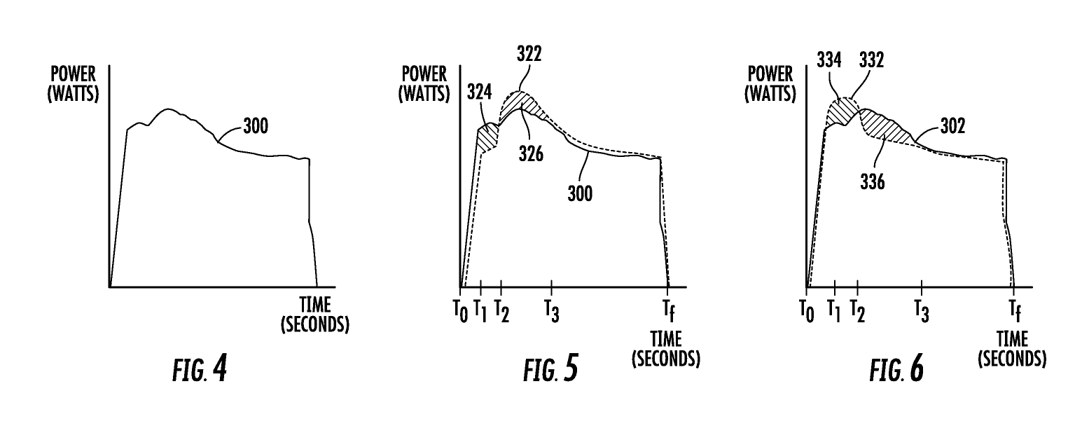

Referring to FIGS. 1 and 5, the microprocessor 86 is further configured to induce the ultrasonic welding controller 22 to adjust power levels output by the controller 22 to the ultrasonic welding device 20. In particular, the microprocessor 86 can utilize a neural network algorithm 88 stored in the memory device 86 to induce the controller 22 to adjust power levels such that an area under the curve 322 corresponding to a total amount of energy for forming a first weld joint is substantially equal to an area under the curve 322 corresponding to a total amount of energy for forming a desired weld joint.

For example, referring to FIGS. 1 and 5, if the power level output by the controller 22 at the first time (T₁) is less than the associated power level of the desired output power level curve 300 at the first time (T₁), the microprocessor 86 can generate control signals to induce the ultrasonic welding controller 22 to increase the power level output by the controller 22 to the ultrasonic welding device 20 at a second time (T₂) to a third time (T₃) which is greater than associated power levels of the curve 300 from the second time (T₂) to the third time (T₃) utilizing the neural network algorithm 88, such that a total amount of energy output by the controller 22 over a welding time interval (e.g., the time interval T₀-T_{f}) to obtain the first weld joint corresponds to an amount of energy defined by the desired output power level curve 300. It is noted that a total amount of energy output by the controller 22 between times T₀-T₂ is less than associated values of the curve 300, which is shown in region 324. To compensate for this lower amount of outputted energy, the amount of energy output between times T₂-T₃ is greater than associated values of the curve 300, which is shown in region 326. The area of the region 326 is substantially equal to the region 324.

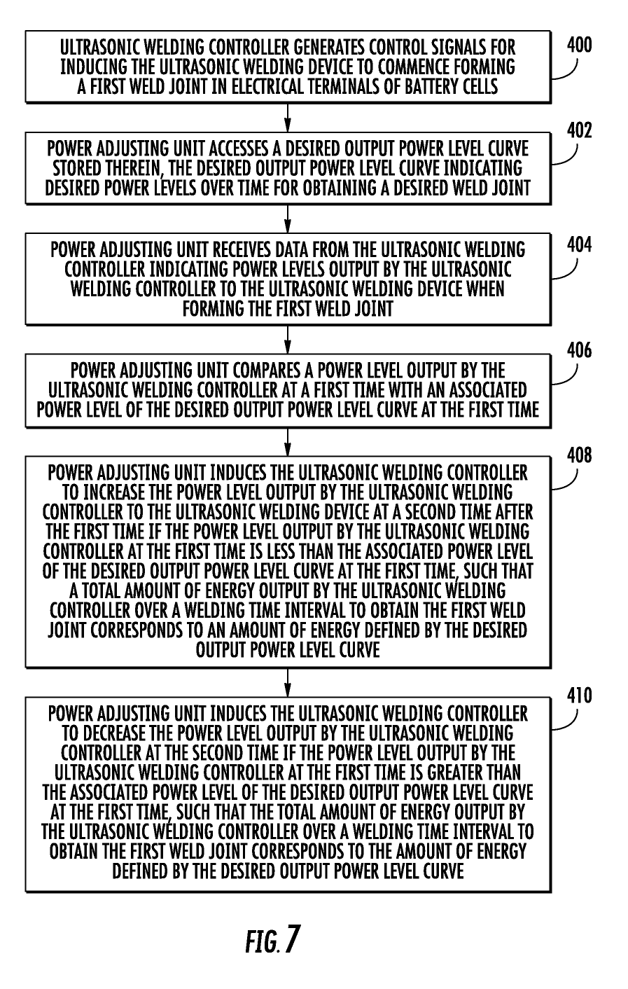

Also, for example, referring to FIGS. 1 and 6, if the power level output by the controller 22 at the first time (T₁) is greater than the associated power level of the desired output power level curve 300 at the first time (T₁), the microprocessor 86 can generate control signals to induce the ultrasonic welding controller 22 to decrease the power level output by the controller 22 to the ultrasonic welding device 20 at a second time (T₂) to a third time (T₃) which is less than associated power levels of the curve 300 from the second time (T₂) to the third time (T₃) utilizing the neural network algorithm 88, such that a total amount of energy output by the controller 22 over welding time interval (e.g., the time interval T₀-T_{f}) to obtain the first weld joint corresponds to an amount of energy defined by the desired output power level curve 300. It is noted that a total amount of energy output by the controller 22 between times T₀-T₂ is greater than associated values of the curve 300, which is shown in region 334. To compensate for this greater amount of outputted energy, the amount of energy output between times T₂-T₃ is less than associated values of the curve 300, which is shown in region 336. The area of the region 336 is substantially equal to the area of the region 334.

Referring to FIGS. 1-3 and 7, an overview of a method for forming a weld joint utilizing the ultrasonic welding system 10 in accordance with another exemplary embodiment is provided.

At step 400, the ultrasonic welding controller 22 generates control signals for inducing the ultrasonic welding device 20 to commence forming at least a first weld joint 150 in the electrical terminals 134, 194 of the battery cells 100, 102, respectively, and the interconnect member 110, to bond the electrical terminals 134, 194, together and to the member 110.

At step 402, the power adjusting unit 24 accesses a desired output power level curve 300 stored therein. The desired output power level curve 300 indicates desired power levels over time for obtaining a desired weld joint.

At step 404, the power adjusting unit 24 receives data from the ultrasonic welding controller 22 indicating power levels output by the ultrasonic welding controller 22 to the ultrasonic welding device 40 when forming the first weld joint 150.

At step 406, the power adjusting unit 24 compares a power level output by the ultrasonic welding controller 22 at a first time T₁ with an associated power level of the desired output power level curve 300 at the first time T₁.

At step 408, the power adjusting unit 24 induces the ultrasonic welding controller 22 to increase the power level output by the ultrasonic welding controller 22 to the ultrasonic welding device 20 at a second time T₂ after the first time T₁ if the power level output by the ultrasonic welding controller at the first time T₁ is less than the associated power level of the desired output power level curve 300 at the first time T₁, such that a total amount of energy output by the ultrasonic welding controller 22 over welding time interval T₀-T_{f} to obtain the first weld joint 150 corresponds to an amount of energy defined by the desired output power level curve 300.

At step 410, the power adjusting unit 24 induces the ultrasonic welding controller 22 to decrease the power level output by the ultrasonic welding controller 22 at the second time T₂ if the power level output by the ultrasonic welding controller at the first time T₁ is greater than the associated power level of the desired output power level curve 300 at the first time T₁, such that the total amount of energy output by the ultrasonic welding controller 22 over a welding time interval T₀-T_{f} to obtain the first weld joint 150 corresponds to the amount of energy defined by the desired output power level curve 300.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention may include only some of the described embodiments. Accordingly, the claimed invention is not to be seen as limited by the foregoing description.

1. An ultrasonic welding system, comprising:
an ultrasonic welding device having an ultrasonic horn, an anvil, an ultrasonic actuator operably coupled to the ultrasonic horn, and a positioning actuator, the ultrasonic horn having a tip portion with a knurled region;
an ultrasonic welding controller configured to generate control signals to induce the positioning actuator to move the ultrasonic horn toward the anvil, the ultrasonic welding controller further configured to generate control signals to induce the ultrasonic actuator to vibrate the ultrasonic horn to commence forming a first weld joint;
a power adjusting unit operably communicating with the ultrasonic welding controller;
the power adjusting unit having an internal memory device with a desired output power level curve stored therein, the desired output power level curve indicating desired power levels over time for obtaining a desired weld joint;
the power adjusting unit further having a microprocessor that receives data from the ultrasonic welding controller indicating power levels output by the ultrasonic welding controller to the ultrasonic welding device when forming the first weld joint;
the microprocessor compares a power level output by the ultrasonic welding controller at a first time with an associated power level of the desired output power level curve at the first time; and
the microprocessor generates control signals to induce the ultrasonic welding controller to increase the power level output by the ultrasonic welding controller to the ultrasonic welding device at a second time after the first time if the power level output by the ultrasonic welding controller at the first time is less than the associated power level of the desired output power level curve at the first time, such that a total amount of energy output by the ultrasonic welding controller over welding time interval to obtain the first weld joint corresponds to an amount of energy defined by the desired output power level curve.

2. The ultrasonic welding system of claim 1, wherein the microprocessor further generates control signals to induce the ultrasonic welding controller to decrease the power level output by the ultrasonic welding controller at the second time if the power level output by the ultrasonic welding controller at the first time is greater than the associated power level of the desired output power level curve at the first time, such that the total amount of energy output by the ultrasonic welding controller over a welding time interval to obtain the first weld joint corresponds to the amount of energy defined by the desired output power level curve.

3-4. (canceled)

5. The ultrasonic welding system of claim 1, wherein the first weld joint has a tensile strength of 400-2000 Newtons with a resistivity in a range of 25-100 micro-ohms with a weld joint surface area of 50 millimeters²-200 millimeters².

6. The ultrasonic welding system of claim 1, wherein the ultrasonic horn has a head portion, the tip portion, and a central portion coupled to the head portion and the tip portion.

7. The ultrasonic welding system of claim 1, wherein the anvil has a knurled region.

8. An ultrasonic welding system, comprising:
an ultrasonic welding device having an ultrasonic horn, an anvil, an ultrasonic actuator operably coupled to the ultrasonic horn, and a positioning actuator;
an ultrasonic welding controller configured to generate control signals to induce the positioning actuator to move the ultrasonic horn toward the anvil, the ultrasonic welding controller further configured to generate control signals to induce the ultrasonic actuator to vibrate the ultrasonic horn to commence forming a first weld joint having a tensile strength of 400-2000 Newtons with a resistivity in a range of 25-100 micro-ohms with a weld joint surface area of 50 millimeters²-200 millimeters²;
a power adjusting unit operably communicating with the ultrasonic welding controller;
the power adjusting unit having an internal memory device with a desired output power level curve stored therein, the desired output power level curve indicating desired power levels over time for obtaining a desired weld joint;
the power adjusting unit further having a microprocessor that receives data from the ultrasonic welding controller indicating power levels output by the ultrasonic welding controller to the ultrasonic welding device when forming the first weld joint;
the microprocessor compares a power level output by the ultrasonic welding controller at a first time with an associated power level of the desired output power level curve at the first time; and
the microprocessor generates control signals to induce the ultrasonic welding controller to increase the power level output by the ultrasonic welding controller to the ultrasonic welding device at a second time after the first time if the power level output by the ultrasonic welding controller at the first time is less than the associated power level of the desired output power level curve at the first time, such that a total amount of energy output by the ultrasonic welding controller over welding time interval to obtain the first weld joint corresponds to an amount of energy defined by the desired output power level curve.

9. The ultrasonic welding system of claim 8, wherein the ultrasonic horn has a tip portion with a knurled region, and the anvil has a knurled region.
